(19) United States
(12) Patent Application Publication
(10) Pub. No.: US 2025/0083727 A1
(43) Pub. Date: Mar. 13, 2025

(54) Product Delivery, Transport, and Storage Apparatuses

(71) Applicant: David M. Candelario, James Island, SC (US)

(72) Inventor: David M. Candelario, James Island, SC (US)

(21) Appl. No.: 18/957,175

(22) Filed: Nov. 22, 2024

Related U.S. Application Data
(63) Continuation-in-part of application No. 17/595,985, filed on Dec. 1, 2021.

(51) Int. Cl. B62B 3/10; B60L 53/57; B62B 3/02; B62B 5/00; B62B 5/06

(52) U.S. Cl. CPC B62B 3/10; B60L 53/57; B62B 3/02; B62B 5/0033; B62B 5/0076; B62B 5/067; B62B 2204/02; B62B 2204/04; B62B 2301/254

(57) ABSTRACT

The invention provides an autonomous delivery and storage system comprising a mobile robot, referred to as a porch bot, and a support vehicle, the mother bot. The porch bot features a modular shelved storage shell for transporting various products, including temperature-sensitive goods, with integrated systems for precise temperature control. It utilizes omni-wheels for versatile mobility, advanced navigation systems for real-time route optimization, and a power-sharing capability for energy efficiency. The mother bot assists with the loading, unloading, and transport of porch bots, featuring an adjustable height lift and additional temperature support systems. The system's integrated navigation, communication, and energy management technologies allow for seamless operation in diverse environments, making it suitable for both residential and commercial deliveries. This invention addresses the challenges of modern logistics by improving delivery efficiency, maintaining product integrity, and reducing operational costs through automation and advanced environmental control.

### CROSS-REFERENCE TO RELATED APPLICATIONS

In compliance with 35 U.S.C. 102 (b)(2)(C) and the requirements set forth in the Manual of Patent Examining Procedure (MPEP), this statement is to establish that the subject matter disclosed in the Provisional Application No. 63/198,686 (188DMC-P0001), PCT Application No. PCT/US21/70626 (188DMC-P0003), 371 application Ser. No. 17/595,985 (188DMC-P0004), PCT Application No. PCT/US22/74828 (188DMC-P0005), and PCT Application No. PCT/US24/12319 (188DMC-P0006) is not prior art to the claimed invention in the present application. This is because the disclosed subject matter and the claimed invention were, not later than the effective filing date of the claimed invention, owned by the same person or subject to an obligation of assignment to the same person.

I, Gregory D Carson, as the patent attorney of record for David M. Candelario, hereby declare that the subject matter disclosed in the above referenced applications and the claimed invention in the present application were, not later than the effective filing date of the claimed invention in the present application, owned by David M. Candelario.

### BACKGROUND OF THE INVENTION

### Technical Field

This invention relates generally to a product transport and storage apparatus in the form of bots which aid human activity. The invention makes the human activity less strenuous, more efficient and more productive. A primary field of use is urban and suburban food distribution.

This invention relates generally to a comprehensive system for automated product delivery, transportation, and storage. More specifically, it pertains to technologies that leverage autonomous robotic units to handle the logistics of delivering and storing various products, including but not limited to perishable goods, temperature-sensitive items, and general consumer products. These systems aim to optimize the efficiency, safety, and reliability of modern delivery operations in both residential and commercial settings.

This invention relates generally to apparatuses and devices for automated material handling, delivery logistics, and environmental control during transport and storage operations. Such systems are designed to manage the transportation of products from vendors to end-users, ensuring that items arrive in optimal condition. This method can be adapted to work in conjunction with various transportation modalities, including ground vehicles, aerial drones, and marine delivery systems, allowing for versatility in different environments and applications.

This invention relates more particularly to a mobile robotic platform designed to autonomously transport, deliver, and store products while maintaining precise environmental conditions such as temperature, humidity, and protection from the elements. The system's advanced features include navigation capabilities utilizing GPS (Global Positioning System) and AI-based optimization, remote control and monitoring, integrated energy management systems, and real-time communication with central control units or users. The invention enhances the overall logistics chain by automating key processes and ensuring that goods are delivered efficiently, safely, and in optimal condition, regardless of the external environment.

The present invention relates to the field of automated systems and apparatuses for product delivery, transportation, and storage, particularly those involving mobile robotic units designed for handling and distributing goods. The invention pertains to technologies involving autonomous robotic platforms, specifically designed to transport and deliver products, including perishable and temperature-sensitive goods, in both residential and commercial environments.

This invention falls under the classification of automated material handling devices, such as those found in U.S. Patent Classifications B62D 57/032 for “Vehicles or parts thereof adapted for transport, e.g., for goods distribution” and G05D 1/00 for “Systems for controlling autonomous devices or machines.” The claimed subject matter encompasses mobile robots with advanced features for environmental sensing, navigation, temperature regulation, and remote control, contributing to the automation of delivery and storage operations. These systems may integrate GPS navigation, artificial intelligence (AI) for route optimization, and communication technologies for real-time tracking and interaction with users or centralized management systems.

The invention also addresses the field of temperature-controlled transportation systems classified under F25D 23/00 for “Refrigeration or cooling apparatus for storage, distribution, or handling of goods,” wherein the system can maintain a controlled internal environment to ensure the quality and integrity of the transported products. Additionally, it relates to the field of energy management systems, focusing on shared power transfer and wireless energy distribution technologies, which contribute to the operational efficiency of autonomous delivery and storage apparatuses.

In summary, the invention pertains to the fields of autonomous robotic systems, automated material handling, temperature-controlled storage, and energy management technologies, with a focus on improving the efficiency, safety, and reliability of modern delivery and storage systems for a wide range of products.

### Background Art

Traditionally food at a grocery store is placed in bags which a person then carries by hand to their vehicle. They transport the food home in their vehicle. They carry the bags into their home.

People who have a difficulty placing food in bags, removing food from bags, carrying bags, or lifting bags have get assistance from people who can carry and work with food in bags to get their groceries. People who having difficulty carrying bags and working with food in bags are restricted from the work of urban and suburban food distribution.

In light of the foregoing prior art, there is a need to enable more people to participate in efficient and productive urban and suburban food distribution.

In the field of product delivery and storage, various systems and apparatuses have been developed to automate the handling and transportation of goods, particularly those that involve autonomous mobile platforms. Conventional delivery systems typically rely on human-operated vehicles and manual processes, which are prone to inefficiencies, errors, and limitations in scalability. Furthermore, while some autonomous robotic systems exist, they often lack the sophistication needed to address the complexities of modern delivery logistics, especially when dealing with temperature-sensitive products or complex delivery environments.

### RELATED ART

Autonomous Delivery Robots: Several prior art systems, such as small delivery robots developed by companies like Starship Technologies and Amazon Robotics, have been designed to autonomously transport goods from a distribution center to an end-user. These systems typically involve wheeled robots equipped with basic navigation systems and compartments for carrying goods. However, these existing solutions are often limited in their ability to handle a variety of products, particularly temperature-sensitive goods. Additionally, they are constrained by their navigation systems, which may not be able to handle complex environments or long-distance deliveries effectively.

Temperature-Controlled Transport Systems: There are known technologies in the field of temperature-controlled transport, such as refrigerated trucks or delivery containers that maintain the temperature of perishable goods. However, these systems are often large, cumbersome, and require significant energy resources. They also rely on manual intervention for loading, unloading, and delivery, making them less efficient in comparison to fully autonomous solutions. Additionally, existing systems often lack real-time monitoring and optimization features that can adjust to dynamic delivery conditions.

Omni-Wheel Mobility Platforms: Existing omni-wheel mobility platforms, like those used in warehouse automation (e.g., Kiva Systems, now part of Amazon), offer enhanced maneuverability but are typically designed for controlled environments. They are often restricted to indoor use and lack the robustness required for outdoor delivery applications, especially in varied weather conditions. Furthermore, their ability to integrate with delivery logistics, real-time navigation, and environmental control systems remains limited.

### Problems in the Prior Art

Lack of Environmental Control: Existing delivery robots and platforms do not adequately address the need to maintain precise temperature and humidity control for perishable and temperature-sensitive products. This limits their applicability for transporting goods that require specific storage conditions, such as food, pharmaceuticals, and electronics.

Inefficient Energy Management: Conventional systems often suffer from inefficiencies in energy management, requiring frequent recharging or battery swaps. They also lack the capability for power sharing or transferring energy between devices, which can hinder operational efficiency, particularly in large-scale delivery operations.

Limited Navigation and Real-Time Adaptation: Many existing autonomous delivery systems rely on basic GPS navigation and do not possess the ability to adapt to real-time changes in the delivery environment. This can result in delays, incorrect deliveries, or even operational failures in complex or dynamically changing environments, such as urban areas with heavy traffic, construction, or weather disruptions.

Solutions Provided by the Applicant's Invention:

Comprehensive Environmental Control: The applicant's invention provides advanced temperature and environmental control systems integrated directly into autonomous delivery robots, ensuring that products can be maintained at precise temperatures, whether below freezing, refrigerated, or above room temperature. This addresses the need for handling a wide range of products, including perishable goods, pharmaceuticals, and heat-sensitive electronics.

Advanced Energy Management and Power Sharing: The invention incorporates an innovative energy management system that allows for the sharing and transfer of power between autonomous robots and other devices. This capability reduces downtime and increases the efficiency of delivery operations by enabling robots to support each other during extended delivery routes.

Enhanced Navigation and Adaptability: The applicant's invention features sophisticated navigation systems that go beyond traditional GPS. By integrating AI-based route optimization, real-time position streaming, and multi-sensor input (including optical, infrared, and satellite imagery), the system can adapt to changes in the environment dynamically, improving delivery accuracy and efficiency.

Versatile Mobility: The use of powered omni-wheels allows the delivery robots to navigate a wide range of terrains and environments, from smooth indoor surfaces to rough outdoor conditions. This versatility expands the operational range of the robots, enabling them to perform deliveries in both urban and rural settings with equal efficiency.

As mentioned, the porch bot's versatile design and advanced technological features make it highly adaptable for a wide range of industrial applications. Its ability to autonomously navigate, manage environmental conditions, and maintain real-time communication opens up new opportunities across several sectors, enhancing efficiency, reducing costs, and optimizing logistics processes.

Pharmaceuticals: The porch bot's precise environmental control capabilities make it an ideal solution for the transportation of pharmaceutical products, including temperature-sensitive vaccines, medications, and biologics. The ability to maintain specific temperatures (below freezing, refrigerated, or above room temperature) ensures that pharmaceutical products are kept in optimal condition, reducing spoilage and maintaining product efficacy. This is particularly valuable for transporting critical products like insulin, COVID-19 vaccines, and other biologics that require stringent temperature control. Additionally, the real-time monitoring and tracking systems ensure that regulatory standards, such as those outlined in the Good Distribution Practice (GDP) for pharmaceuticals, are met, allowing seamless integration with the healthcare supply chain. The system could be deployed in hospitals, pharmacies, and pharmaceutical distribution centers for last-mile delivery of sensitive medications to patients and healthcare providers.

Electronics: The electronics industry frequently requires the delivery of delicate and heat-sensitive components, such as semiconductors, circuit boards, and high-value consumer electronics. These products are often susceptible to environmental factors like humidity, dust, and temperature fluctuations. The porch bot's sealed storage shell with integrated all-weather seals and environmental regulation can protect sensitive electronics during transport. The system's shock-absorbing shelving further ensures that fragile electronics are safeguarded from vibrations and impacts during transit. Moreover, real-time tracking and monitoring provide manufacturers and suppliers with continuous updates on the condition of their shipments, allowing them to ensure product integrity throughout the supply chain. This is critical for sectors like consumer electronics, medical devices, and automotive electronics, where timely and secure delivery is paramount.

Food and Grocery Industry: The ability to control temperatures within specific ranges makes this invention an optimal solution for the food and grocery industry, where the transportation of perishable goods, such as fresh produce, meat, and dairy, is crucial. The system can maintain products at refrigerated or frozen temperatures, ensuring that food remains fresh from distribution centers to end consumers. Additionally, dry ice or vapor compression refrigeration systems can be integrated for specialized deliveries that require sub-zero temperatures. With the growing demand for grocery delivery services and the rise of e-commerce in the food sector, this system provides a robust and scalable solution for maintaining product quality during last-mile delivery in urban and suburban settings. Furthermore, the omni-wheel technology allows the porch bot to navigate diverse terrains, ensuring efficient delivery to homes, restaurants, and grocery stores.

Urban Infrastructure and Smart Cities: With the rise of smart cities, there is an increasing need for efficient, autonomous systems that can manage the delivery and transportation of goods in densely populated urban areas. The porch bot, equipped with AI-driven navigation systems, can contribute to urban infrastructure by reducing traffic congestion and lowering carbon emissions through optimized delivery routes and electric-powered operations. The system's real-time adaptability allows it to navigate through busy city streets, avoiding obstacles such as construction zones or crowded pedestrian areas. The porch bot can also integrate with city-wide smart traffic management systems, enhancing overall efficiency and promoting sustainable urban logistics. Applications extend to the delivery of essential goods such as food, medical supplies, and consumer products, contributing to the development of resilient urban ecosystems.

E-Commerce and Retail: In the e-commerce and retail sectors, the porch bot offers a solution for efficient, contactless delivery, addressing the growing demand for quick and reliable fulfillment services. Retailers can utilize the system to automate the delivery of a wide range of products, from general merchandise to high-value items like luxury goods and electronics. The system's real-time tracking and video display panels can enhance customer satisfaction by providing updates and allowing recipients to interact with the delivery bot upon arrival. This not only improves delivery efficiency but also adds a level of transparency and customer engagement. For businesses, the automation reduces labor costs and human errors in the delivery process.

Perishable Goods and Temperature-Controlled Logistics: Beyond pharmaceuticals and food, this technology can be applied to industries that handle other temperature-sensitive materials, such as cosmetics, chemicals, and even specialized industrial products. Companies that manufacture or distribute products requiring stable environmental conditions during transport (e.g., chemicals that react to temperature changes or cosmetics that degrade in high heat) can benefit from the porch bot's integrated temperature control systems. Furthermore, by enabling the transportation of goods across diverse environments-ranging from urban centers to rural areas-without compromising the integrity of the cargo, the system broadens its applicability to specialty logistics providers.

Automotive and Aerospace Industries: Automotive and aerospace manufacturers often require just-in-time deliveries of critical components such as engines, sensors, and electronics. The porch bot's advanced navigation and environmental control systems make it an ideal solution for transporting these high-value items, ensuring that temperature, humidity, and shock levels are monitored and controlled. The autonomous system can be integrated into assembly lines for delivering parts to manufacturing plants or distributed to remote areas for specialized assembly projects.

The porch bot's adaptability across multiple industries demonstrates its significant potential in modern logistics, from pharmaceuticals to electronics, food, and beyond. Its ability to maintain precise environmental control, efficiently navigate through complex environments, and integrate seamlessly with existing urban and industrial infrastructure makes it a commercially viable solution for industries that demand reliability, scalability, and efficiency in product transport. This versatility ensures that the porch bot can meet the diverse logistical needs of today's rapidly evolving marketplace, providing both businesses and consumers with innovative, automated delivery solutions. In conclusion, the applicant's invention addresses critical limitations in the prior art by providing a more comprehensive, efficient, and adaptable system for autonomous product delivery and storage, particularly in environments where temperature control and real-time adaptability are essential.

In light of the foregoing prior art, there is a critical need for a comprehensive, multi-functional autonomous delivery and storage system to better address the growing demands of modern logistics and product transportation. Such a system must not only efficiently handle a diverse range of products-including perishable, temperature-sensitive, and fragile items but also ensure optimal environmental conditions are maintained throughout the delivery process. Additionally, there is a need to enhance energy efficiency through innovative power management solutions, enabling longer operational periods and seamless power sharing between devices. Furthermore, advanced navigation capabilities that can dynamically adapt to real-time changes in the environment are essential to reduce delivery errors, minimize delays, and improve overall operational scalability.

### BRIEF SUMMARY OF THE INVENTION

The present invention provides an advanced autonomous delivery and storage system designed to optimize the transportation of various products, particularly those that require precise environmental control, such as temperature-sensitive and perishable goods. The system is built around a mobile robotic platform, referred to as the porch bot, which is capable of autonomously navigating diverse environments while maintaining the integrity of the products being transported. Additionally, a mother bot is included to assist with the lifting, loading, and unloading of one or more porch bots, further enhancing the system's operational flexibility.

At the core of the invention is the integration of several key technologies that address limitations in the prior art:

Comprehensive Environmental Control: The porch bot features advanced temperature regulation systems, including cooling and heating apparatuses, to ensure that the interior environment can be precisely maintained for products that require specific storage conditions. This includes the ability to maintain temperatures below freezing, refrigerated, or above room temperature, making the system suitable for transporting goods such as food, pharmaceuticals, and sensitive electronics.

Advanced Navigation and Real-Time Adaptation: The invention incorporates sophisticated navigation systems that utilize GPS, AI-based route optimization, and multi-sensor inputs (e.g., optical, infrared, and satellite imagery). These features enable the porch bot to dynamically adapt to real-time changes in the environment, such as road conditions, traffic, and obstacles, ensuring more accurate and efficient delivery operations.

Energy Management and Power Sharing: The invention addresses the energy inefficiencies seen in previous systems by implementing a robust power management solution. This includes the ability for porch bots to share and transfer power between each other, reducing downtime and ensuring continuous operation over extended delivery routes. The system's battery storage also supports longer operational periods without frequent recharging.

Versatile Mobility: Equipped with omni-wheels, the porch bot is capable of navigating a wide variety of terrains and environments, both indoors and outdoors. This enhanced mobility ensures that the system can operate in urban, suburban, and rural settings with ease, overcoming limitations of existing delivery systems that are often restricted to smoother, more controlled surfaces.

The inventive concept behind this system lies in the seamless integration of autonomous navigation, environmental control, and energy efficiency, combined with the flexibility to handle a diverse array of products in varying delivery conditions. The system not only improves the speed and accuracy of deliveries but also ensures the safe transport of goods that require special handling.

### OBJECTS OF THE INVENTION

The objects of this invention include:

Enhanced Product Integrity: Ensuring that products, particularly perishable and temperature-sensitive items, are maintained under optimal environmental conditions throughout the delivery process.

Increased Efficiency: Reducing downtime and improving the overall efficiency of the delivery process through advanced energy management and power-sharing capabilities.

Adaptability: Enabling the system to dynamically adjust to real-time changes in the delivery environment, ensuring more accurate and reliable operations.

Versatile Operation: Expanding the operational capabilities of autonomous delivery systems to navigate various terrains and environments, making the system suitable for diverse delivery scenarios.

This invention solves significant problems present in the prior art by providing a fully integrated solution for automated delivery, combining navigation, environmental control, energy management, and operational versatility into a single cohesive system.

According to a first aspect of the invention, there is a porch bot for transporting a plurality of products, the first of said plurality of products being a first product, comprising a storage shell having a shelved interior for storing said plurality of products on a plurality of shelves, the first of said plurality of shelves being a first shelf, a pair of brace rails on two external sides of said storage shell, and a handle frame displaceable along one of said pair of brace rails to a fixed position in register with said plurality of shelves to support said plurality of products configured to slide out of said shelled interior.

According to a second aspect of the invention, there is a porch bot wherein transporting products comprises delivery from a vendor to an address.

According to a third aspect of the invention, there is a porch bot wherein transporting products comprises maintaining a product temperature of less than four degrees Celsius.

According to a fourth aspect of the invention, there is a porch bot wherein transporting products comprises maintaining a product temperature of less than negative seventeen degrees Celsius.

According to a fifth aspect of the invention, there is a porch bot wherein transporting products comprises maintaining a product temperature of above fifty degrees Celsius.

According to a sixth aspect of the invention, there is a porch bot wherein a handle frame comprises a pair of arms which clasp opposite sides of said storage shell including a plurality of sides comprising a door into said shelved interior.

According to a seventh aspect of the invention, there is a porch bot further comprising at least a first and a second separate interior compartment.

According to an eighth aspect of the invention, there is a porch bot further comprising a cooling apparatus for maintaining cooler interior temperatures relative to an environment comprising dry ice.

According to a ninth aspect of the invention, there is a porch bot further comprising a heating apparatus for maintaining warmer interior temperatures relative to an environment comprising radiant electric heat.

According to a tenth aspect of the invention, there is a porch bot wherein said storage shell further comprises a plurality of all-weather seals said plurality of all-weather seals including at least a first all-weather seal to make said storage shell wind-tight and a second all-weather seal to make said storage shell water-tight.

According to an eleventh aspect of the invention, there is a porch bot further comprising omni wheels wherein said omni wheels are powered and remotely controlled.

According to a twelfth aspect of the invention, there is a porch bot further comprising a battery/power storage further comprising a sharable power transfer.

According to a thirteenth aspect of the invention, there is a porch bot further comprising a plurality of image/video display panels further comprising a flat video display and an audio system.

According to a fourteenth aspect of the invention, there is a porch bot further comprising a navigation system, a GPS, and position streaming system enhanced in over/under layers with at least one of a location tracking label comprising any combination of planet codes, cubic codes, bar codes, and tracking identifiers, a plurality of optical/video systems integration comprising any combination of ultra violet, infrared, and/or satellite imagery, and/or a geolocation data.

According to a fifteenth aspect of the invention, there is a mother bot for lifting and transporting one or more porch bots comprising a bed having a side to support said porch bots, and an adjustable height lift connected to an opposite side of said bed from said side to support said porch bots, wherein said adjustable height lift is configured to raise, lower, and transport said bed from a surface.

According to a sixteenth aspect of the invention, there is a mother bot wherein an adjustable height lift comprises at least one scissor lift having a plurality of legs, two of said plurality of legs being a first leg and a second leg, one of each connected between opposite sides of said bed to support said porch bots wherein said plurality of legs have rolling wheels at a free end distal from said bed to roll on said surface to transport said mother bot.

According to a seventeenth aspect of the invention, there is a mother bot wherein an adjustable height lift further comprises omni wheels wherein said omni wheels are powered and remotely controlled.

According to an eighteenth aspect of the invention, there is a mother bot wherein an adjustable height lift is powered and remotely controlled.

According to a nineteenth aspect of the invention, there is a mother bot further comprising a battery/power storage further comprising a sharable power transfer.

According to a twentieth aspect of the invention, there is a mother bot further comprising a means of assisting said porch bots in maintaining a product temperature of less than four degrees Celsius.

According to a twenty-first aspect of the invention, there is a mother bot further comprising a means of assisting said porch bots in maintaining a product temperature of less than negative seventeen degrees Celsius.

According to a twenty-second aspect of the invention, there is a mother bot further comprising a means of assisting said porch bots in maintaining a product temperature of above fifty degrees Celsius.

### Advantages of the Invention

The invention offers several significant advantages over prior art in the field of automated product delivery and storage:

Comprehensive Environmental Control: The porch bot can precisely regulate the internal environment to accommodate a wide range of products, including perishable and temperature-sensitive goods. This ensures that products are delivered in optimal condition, whether they require refrigeration, freezing, or elevated temperatures.

Advanced Navigation and Adaptability: Equipped with GPS, AI-based route optimization, and multi-sensor input, the porch bot can dynamically adapt to changing environments. This results in more accurate and efficient delivery, reducing errors and delays in complex or unpredictable delivery conditions.

Energy Efficiency and Power Sharing: The invention includes an advanced energy management system that allows for power sharing between robots, minimizing downtime and extending operational periods. This innovation enhances efficiency and reduces the need for frequent recharging or battery swaps.

Versatile Mobility: The omni-wheel design enables the porch bot to navigate a wide variety of terrains, both indoors and outdoors, allowing for flexibility in urban, suburban, and rural delivery scenarios. This versatility extends the operational range of the system.

Automated Loading and Unloading: The inclusion of the mother bot enhances the overall delivery process by automating the lifting, loading, and unloading of porch bots. This reduces manual labor and streamlines the process, improving operational speed and efficiency.

Real-Time Tracking and Monitoring: Integrated navigation and communication systems allow for real-time tracking of deliveries, enabling better oversight, customer communication, and operational transparency.

The invention improves the efficiency, reliability, and adaptability of modern delivery systems, offering a comprehensive solution for transporting a diverse array of products under optimal conditions.

The invention will now be described, by way of example only, with reference to the accompanying drawings in which:

### BRIEF DESCRIPTION OF THE FIGURES

FIG. 1 is a side view of the mother bot with five porch bots loaded to show the product delivery, transport, and storage apparatuses according to the invention;

FIG. 2 is a back perspective view of a porch bot of the product delivery, transport, and storage apparatuses according to the invention; and

FIG. 3 is a perspective view of a mother bot of the product delivery, transport, and storage apparatuses according to the invention.

### DETAILED DESCRIPTION OF THE INVENTION

The detailed embodiments of the present invention are disclosed herein. The disclosed embodiments are merely exemplary of the invention, which may be embodied in various forms. The details disclosed herein are not to be interpreted as limiting, but merely as the basis for the claims and as a basis for teaching one skilled in the art how to make and use the invention.

References in the specification to “one embodiment,” “an embodiment,” “an example embodiment,” etcetera, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

Index of Labelled Features in Figures. Features are listed in numeric order by Figure in numeric order.

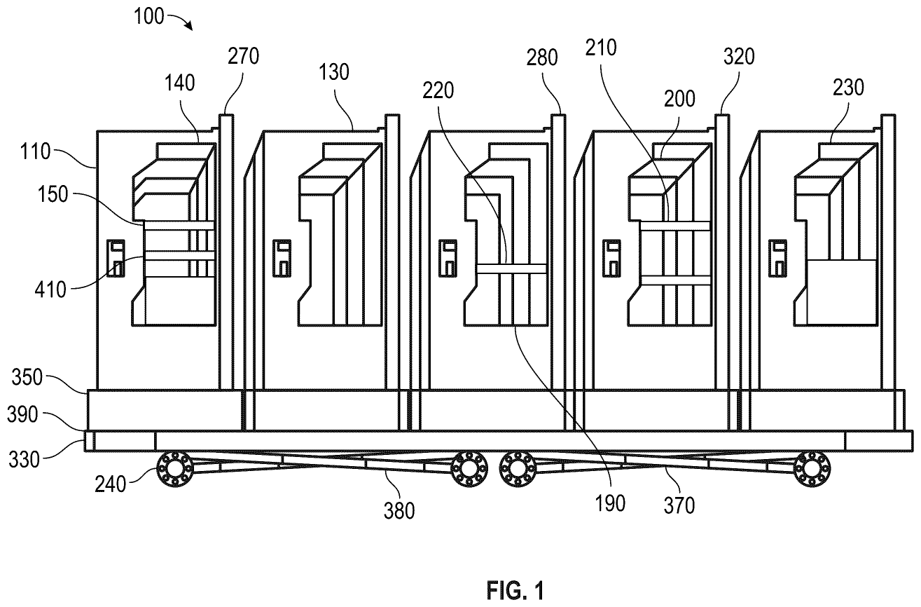

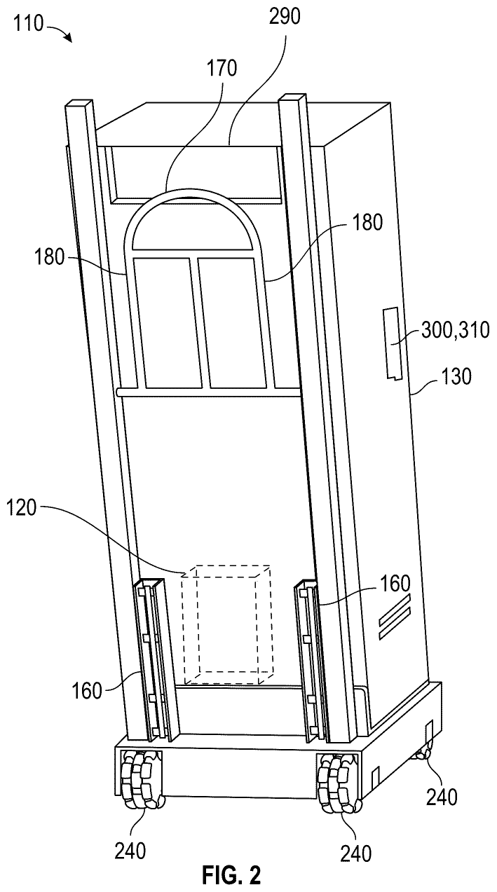

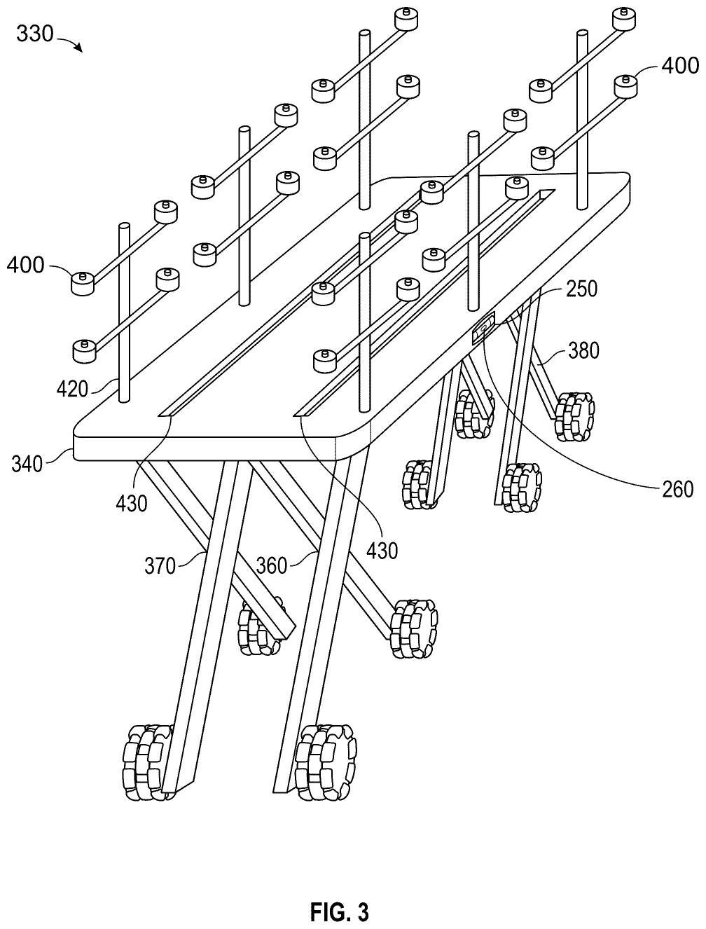

Referring to the Figures, there is shown in FIGS. 1, 2, 3, and 4 the following features:

Element 100 which are product delivery, transport, and storage apparatuses.

Element 110 which is a porch bot.

Element 120 which is a product.

Element 130 which is a storage shell.

Element 140 which is a shelved interior of the storage shell.

Element 150 which is a shelf.

Element 160 which is a pair of brace rails on two external sides of the storage shell.

Element 170 which is a handle frame.

Element 180 which is a pair of arms of the handle frame.

Element 190 which is a door.

Element 200 which is a separate interior compartment in the porch bot.

Element 210 which is a cooling apparatus for maintaining cooler interior temperatures relative to an environment.

Element 220 which is a heating apparatus for maintaining warmer interior temperatures relative to an environment.

Element 230 which is a plurality of all weather (wind tight, water tight) seals.

Element 240 which is an omni wheel.

Element 250 which is a battery/power storage.

Element 260 which is a sharable power transfer.

Element 270 which is a plurality of image/video display panels.

Element 280 which is a flat video display.

Element 290 which is an audio system.

Element 300 which is a navigation system Element 310 which is a GPS.

Element 320 which is a position streaming system.

Element 330 which is a mother bot.

Element 340 which is a bed of the mother bot.

Element 350 which is a side of the mother bot to support the porch bots.

Element 360 which is an adjustable height lift.

Element 370 which is a scissor lift.

Element 380 which is a leg.

Element 390 which is a surface.

Element 400 which is a rolling wheel.

Element 410 which is a means of assisting said porch bots in maintaining a product temperature.

Element 420 which is an extension arm.

Element 430 which is a parallel channel.

### How to Make the Invention

The invention comprises two primary components: the porch bot, a versatile mobile autonomous delivery robot, and the mother bot, a support vehicle designed to assist in loading, unloading, and transporting porch bots. The process of making the invention involves assembling various subsystems and components that enable the porch bot and mother bot to function efficiently and autonomously.

### Porch Bot Construction:

### Storage Shell:

The storage shell is the main housing of the porch bot. It is crafted from high-strength, lightweight materials such as high-impact polymers or aluminum alloys to provide durability while keeping the robot light and energy-efficient. The shell should feature weatherproofing measures, including all-weather seals and insulation, to protect internal components from environmental elements like rain, wind, and dust.

The interior of the shell is designed with modular shelving units. These shelves can be adjustable or removable to accommodate products of various sizes. The shelving units can also be reinforced to handle heavier items. For added protection, each shelf can be padded or lined with shock-absorbent materials to safeguard fragile products.

### Brace Rails and Handle Frame:

Brace rails are securely attached to the external sides of the storage shell. These rails serve as guide tracks for a displaceable handle frame. The handle frame can be adjusted along the brace rails to lock into specific positions, aligning with the interior shelves. This design facilitates easy loading and unloading of products.

The handle frame should be constructed from robust materials, such as stainless steel or reinforced polymers, and equipped with a locking mechanism to prevent movement during transport. The arms of the handle frame may include soft-touch grips or protective pads to prevent damage to the storage shell and to provide a secure hold on the products during transit.

### Temperature Control Systems:

Cooling System: To maintain a refrigerated environment, thermoelectric cooling units or vapor compression refrigeration systems can be integrated into the storage shell. These units are equipped with temperature sensors and programmable controllers to maintain consistent temperatures. A failsafe mechanism, such as redundant cooling units or battery backup, ensures that the cooling system remains operational during the entire delivery process.

Freezing Capabilities: For products requiring sub-zero temperatures, such as frozen food or pharmaceuticals, more advanced cooling solutions, like cryogenic systems (e.g., dry ice or liquid nitrogen), may be used. These systems can be monitored via temperature sensors to ensure precise control.

Heating System: Radiant electric heaters can be embedded within the walls of the storage shell to provide warmth when required. These heaters are controlled by a thermostat to regulate temperatures above 50° C., making the porch bot suitable for transporting goods that need to stay warm, such as hot meals or heat-sensitive chemicals.

### Omni-Wheels:

The omni-wheels allow the porch bot to move seamlessly in all directions. These wheels are designed with multiple rollers arranged perpendicularly to the wheel's rotation, enabling omnidirectional movement. The wheels are powered by compact, high-torque electric motors and should be equipped with independent suspension systems to absorb shocks from uneven terrain. To enhance traction on different surfaces, the wheel rollers can be made from rubberized materials or feature tread patterns for better grip.

### Battery and Power Storage:

The porch bot relies on an advanced lithium-ion battery pack, which offers a high energy density to power the bot's movement, temperature control systems, and electronic components. The battery pack is designed for easy replacement or recharging and is integrated with a battery management system (BMS) to monitor battery health, prevent overcharging, and ensure optimal power distribution.

A unique feature of the porch bot is its power-sharing capability. This allows one porch bot to transfer power to another, which can be especially useful during extended delivery routes or in remote areas where recharging stations may not be readily available.

### Navigation and Communication Systems:

The porch bot's navigation system includes a GPS module for tracking its location in real time. The system also incorporates AI-driven route optimization algorithms to calculate the most efficient delivery paths, taking into account factors such as traffic, road conditions, and delivery schedules.

Multi-sensor arrays, including optical cameras, infrared sensors, ultrasonic sensors, and satellite imagery integration, enable the porch bot to detect and avoid obstacles. These sensors feed data into the central processing unit, allowing the bot to make real-time adjustments to its route and ensure safe navigation in complex environments.

Communication modules, such as 4G/5G cellular, Wi-Fi, and Bluetooth, facilitate remote control and monitoring. The porch bot can receive updates or new delivery instructions wirelessly, and operators can track its location, monitor the internal temperature, and adjust settings remotely.

### Video Display Panels:

The porch bot is equipped with exterior video display panels capable of showing dynamic content. These panels can be used to display delivery information, advertisements, or customer-specific messages. The video panels should be made from durable, weather-resistant materials and offer high-resolution displays for clear visibility. An integrated audio system can provide voice notifications or customer alerts during delivery.

### Mother Bot Construction:

### Adjustable Height Lift:

The mother bot features a bed for supporting one or more porch bots. This bed is attached to a scissor lift mechanism, which can raise or lower the porch bots to match the height of loading docks, transport vehicles, or storage areas. The scissor lift is powered by electric actuators and includes safety features like limit switches and load sensors to prevent overloading or tipping.

The bed should be constructed from lightweight, durable materials such as aluminum or reinforced composites to handle heavy loads while remaining easy to maneuver.

### Powered Omni-Wheels:

Like the porch bot, the mother bot uses powered omni-wheels for multi-directional mobility. These wheels are optimized for carrying heavier loads and are equipped with advanced suspension and stabilization systems to ensure smooth transport, even when fully loaded with multiple porch bots.

### Temperature Assistance System:

The mother bot may include auxiliary temperature control systems to support the porch bots in maintaining their internal temperatures during long-distance transportation or while parked at a delivery hub. These systems could utilize additional refrigeration units, heating elements, or thermal blankets that can be connected to the porch bots via docking interfaces.

### Battery and Power Management:

The mother bot is equipped with a larger battery system to support its operations and to provide backup power for the porch bots when needed. This battery system can be designed with modularity in mind, allowing for easy expansion or replacement. Power-sharing capabilities enable the mother bot to assist in recharging porch bots on the go.

### Assembly and Integration:

The assembly process involves integrating all the components—mechanical, electrical, and software—into a fully functional porch bot and mother bot system. Each component should undergo rigorous testing to ensure proper functionality and durability. Wiring should be carefully routed and secured to prevent damage during operation, and the entire system should be waterproofed or weather-sealed to protect against environmental conditions.

Software installation includes loading the operating system, navigation algorithms, and temperature control programs onto the porch bot's central processor. This software can be updated remotely as new features or improvements become available.

### How to Use the Invention

### Initial Setup:

Charging and Calibration: Before deployment, the porch bot and mother bot need to be fully charged using compatible charging stations or by connecting to a standard power outlet. Calibration includes testing the navigation system, temperature control mechanisms, and sensors to ensure all systems are functioning correctly. The calibration process may also involve setting up the GPS coordinates and route preferences for the delivery area.

Product Loading: To load products into the porch bot, operators can open the storage shell door and place the products onto the interior shelves. For temperature-sensitive products, the user can set the desired internal temperature through the control panel or mobile app. Once loaded, the handle frame can be locked in place to secure the products and prevent movement during transport. For larger deliveries, the shelves can be adjusted or removed to create more space.

### Operation and Navigation:

Route Planning: The porch bot is equipped with an advanced AI-based route optimization system, enabling fully autonomous navigation through complex delivery environments. The route planning algorithm not only considers static data such as road maps and designated delivery addresses but also dynamically incorporates real-time factors including traffic patterns, road closures, and weather conditions. The system integrates multiple data sources, such as GPS, satellite imagery, and traffic monitoring systems, to calculate the most efficient path while minimizing delays and maximizing energy efficiency. For instance, in urban environments with unpredictable traffic, the algorithm can re-route the porch bot in real-time to avoid congested areas or accidents.

The system is also capable of prioritizing deliveries based on the type of product being transported, customer preferences, and delivery deadlines. For example, perishable goods requiring refrigeration may be prioritized for faster delivery over non-perishable items to ensure they arrive in optimal condition. Similarly, high-priority customers or time-sensitive orders can trigger adjustments to the route to meet critical deadlines.

In addition to autonomous route planning, the porch bot can receive pre-programmed delivery instructions from a central control system or mobile application, allowing human operators or vendors to manually set specific delivery paths or destinations. This functionality is particularly useful in controlled environments, such as large industrial complexes or gated communities, where predetermined routes may be more efficient or mandated by local regulations.

To enhance delivery accuracy, the system leverages multi-sensor input, including lidar, optical, infrared, and ultrasonic sensors, to detect obstacles, adjust speed, and navigate around dynamic hazards like pedestrians, cyclists, or road debris. These sensors work in conjunction with the AI-based system to continuously refine the delivery route based on real-time feedback, ensuring safe and timely deliveries.

Finally, the porch bot's route planning system is capable of learning from previous delivery experiences. Through machine learning algorithms, the system can optimize future routes by analyzing historical data on traffic patterns, customer feedback, and delivery outcomes, continuously improving operational efficiency over time. This adaptability allows the porch bot to not only handle routine deliveries but also respond effectively to unforeseen changes in the environment, such as inclement weather or sudden road detours.

Autonomous and Remote Operation: During operation, the porch bot navigates autonomously to its destination, avoiding obstacles and adjusting its route as needed. Remote operators can monitor the bot's progress in real-time through a mobile app or a central dashboard. The app allows users to track the bot's location, check the internal temperature, and receive notifications when deliveries are completed or if any issues arise.

Delivery Process: Upon arriving at the delivery location, the porch bot positions itself near the designated drop-off area. The handle frame can be adjusted to align with the shelves, enabling easy unloading. The bot may also communicate with the recipient via the video display panel or audio system to confirm delivery and provide instructions.

### Mother Bot Usage:

Loading and Unloading Porch Bots: The mother bot assists with the loading and unloading of porch bots. It can lift and lower the porch bots using its adjustable height lift, allowing for seamless transfer between transport vehicles and storage areas. The mother bot's omni-wheels enable it to maneuver porch bots precisely, even in tight or crowded spaces.

Temperature Assistance: During extended transport or when parked for long periods, the mother bot can provide additional temperature support to the porch bots. This can be especially important for deliveries that require the products to remain at a consistent temperature until they reach the end recipient.

### Energy Management:

Power Sharing: When a porch bot requires additional power during a long delivery route, it can dock with another porch bot or the mother bot to share energy. This is particularly useful in large-scale operations where porch bots may need to cover long distances without frequent access to recharging stations. The power-sharing feature allows for continuous operation and minimizes the risk of a porch bot running out of power mid-delivery.

Efficient Recharging: After completing deliveries, the porch bots and mother bots can return to their charging stations to recharge. The system's intelligent energy management software ensures that the bots are charged efficiently, prioritizing those with lower battery levels and scheduling charging during off-peak hours to reduce energy costs.

### Maintenance and Updates:

Routine Maintenance: Regular maintenance is essential to ensure the longevity and reliability of the porch bots and mother bots. This includes inspecting and servicing the battery systems, wheels, temperature control units, and sensors. Software updates can be pushed remotely to enhance functionality, improve navigation algorithms, and introduce new features. Periodic recalibration of sensors and navigation systems ensures that the bots continue to operate accurately and efficiently.

Diagnostics and Troubleshooting: The system includes diagnostic tools that monitor the health of the components in real time. If any issues arise, the system can alert operators to potential problems, such as low battery levels, temperature fluctuations, or sensor malfunctions. Remote diagnostics allow for troubleshooting and resolution of issues without requiring manual intervention, reducing downtime and maintaining operational efficiency.

By following these detailed instructions, users can manufacture, deploy, and operate the autonomous delivery and storage system effectively. The invention is designed to streamline logistics, reduce manual labor, and ensure the safe and efficient transportation of various products, including those requiring specific environmental conditions. Whether in a residential, commercial, or industrial setting, this system offers a scalable and flexible solution to modern delivery challenges.

According to a preferred embodiment of the invention, there is a porch bot for transporting a plurality of products, the first of said plurality of products being a first product, comprising a storage shell having a shelved interior for storing said plurality of products on a plurality of shelves, the first of said plurality of shelves being a first shelf, a pair of brace rails on two external sides of said storage shell, and a handle frame displaceable along one of said pair of brace rails to a fixed position in register with said plurality of shelves to support said plurality of products configured to slide out of said shelved interior.

According to an alternate embodiment of the invention, there is a porch bot wherein transporting products comprises delivery from a vendor to an address.

According to an alternate embodiment of the invention, there is a porch bot wherein transporting products comprises maintaining a product temperature of less than four degrees Celsius.

According to an alternate embodiment of the invention, there is a porch bot wherein transporting products comprises maintaining a product temperature of less than negative seventeen degrees Celsius.

According to an alternate embodiment of the invention, there is a porch bot wherein transporting products comprises maintaining a product temperature of above fifty degrees Celsius.

According to an alternate embodiment of the invention, there is a porch bot wherein a handle frame comprises a pair of arms which clasp opposite sides of said storage shell including a plurality of sides comprising a door into said shelved interior.

According to an alternate embodiment of the invention, there is a porch bot further comprising at least a first and a second separate interior compartment.

According to an alternate embodiment of the invention, there is a porch bot further comprising a cooling apparatus for maintaining cooler interior temperatures relative to an environment comprising dry ice.

According to an alternate embodiment of the invention, there is a porch bot further comprising a heating apparatus for maintaining warmer interior temperatures relative to an environment comprising radiant electric heat.

According to an alternate embodiment of the invention, there is a porch bot wherein said storage shell further comprises a plurality of all-weather seals said plurality of all-weather seals including at least a first all-weather seal to make said storage shell wind-tight and a second all-weather seal to make said storage shell water-tight.

According to an alternate embodiment of the invention, there is a porch bot further comprising omni wheels wherein said omni wheels are powered and remotely controlled.

According to an alternate embodiment of the invention, there is a porch bot further comprising a battery/power storage further comprising a sharable power transfer.

According to an alternate embodiment of the invention, there is a porch bot further comprising a plurality of image/video display panels further comprising a flat video display and an audio system.

According to an alternate embodiment of the invention, there is a porch bot further comprising a navigation system, a GPS, and position streaming system enhanced in over/under layers with at least one of a location tracking label comprising any combination of planet codes, cubic codes, bar codes, and tracking identifiers, a plurality of optical/video systems integration comprising any combination of ultra violet, infrared, and/or satellite imagery, and/or a geolocation data.

According to a preferred embodiment of the invention, there is a mother bot for lifting and transporting one or more porch bots comprising a bed having a side to support said porch bots, and an adjustable height lift connected to an opposite side of said bed from said side to support said porch bots, wherein said adjustable height lift is configured to raise, lower, and transport said bed from a surface.

According to an alternate embodiment of the invention, there is a mother bot wherein an adjustable height lift comprises at least one scissor lift having a plurality of legs, two of said plurality of legs being a first leg and a second leg, one of each connected between opposite sides of said bed to support said porch bots wherein said plurality of legs have rolling wheels at a free end distal from said bed to roll on said surface to transport said mother bot.

According to an alternate embodiment of the invention, there is a mother bot wherein an adjustable height lift further comprises omni wheels wherein said omni wheels are powered and remotely controlled.

According to an alternate embodiment of the invention, there is a mother bot wherein an adjustable height lift is powered and remotely controlled.

According to an alternate embodiment of the invention, there is a mother bot further comprising a battery/power storage further comprising a sharable power transfer.

According to an alternate embodiment of the invention, there is a mother bot further comprising a means of assisting said porch bots in maintaining a product temperature of less than four degrees Celsius.

According to an alternate embodiment of the invention, there is a mother bot further comprising a means of assisting said porch bots in maintaining a product temperature of less than negative seventeen degrees Celsius.

According to an alternate embodiment of the invention, there is a mother bot further comprising a means of assisting said porch bots in maintaining a product temperature of above fifty degrees Celsius.

### Advantages of the Invention

The invention brings forth several groundbreaking advancements that address key challenges in the field of autonomous product delivery, transportation, and storage. These advantages collectively improve the efficiency, flexibility, and reliability of the system, making it a significant improvement over prior art. Below is a detailed overview of these advantages:

### Comprehensive Environmental Control:

Precision Temperature Management: The porch bot is designed to maintain strict temperature control, allowing for the transport of various goods that require specific environmental conditions. Whether it's refrigeration for perishable food, freezing for pharmaceuticals, or maintaining warmth for sensitive electronics, the system ensures that products remain in optimal condition throughout the entire delivery process.

Versatile Temperature Range: Unlike conventional systems that cater to only a narrow range of temperature needs, the porch bot can manage a wide spectrum of temperatures, from below freezing (less than −17° C.) to high heat (above 50° C.), making it suitable for a broader range of products.

### Advanced Navigation and Real-Time Adaptability:

Multi-Sensor Navigation: The system leverages a combination of GPS, AI-driven route optimization, and multi-sensor technologies (e.g., optical, infrared, and satellite imagery) to navigate complex delivery environments. This enables the porch bot to dynamically adapt to real-time changes such as traffic, construction, or unexpected obstacles, ensuring timely and accurate deliveries.

Intelligent Decision-Making: Through advanced algorithms, the system can make smart decisions on the fly, such as rerouting around roadblocks or adjusting delivery schedules based on real-time data, reducing delivery errors and improving overall efficiency.

### Energy Efficiency and Power Sharing:

Innovative Power Management: The porch bot incorporates cutting-edge energy management features that optimize battery usage and extend operational duration. It reduces downtime by enabling porch bots to share power with one another, thus maintaining continuous operation over extended delivery routes without frequent interruptions for recharging.

Sustainable and Scalable Operations: By improving energy efficiency, the system lowers operational costs and supports sustainable practices. This is especially advantageous in large-scale delivery operations where downtime and energy consumption directly impact profitability and scalability.

### Versatile Mobility:

Omni-Wheel Technology: The porch bot's omni-wheel design grants it exceptional maneuverability across a variety of terrains. From smooth indoor surfaces to rough outdoor environments, the system can operate in diverse settings, including urban streets, suburban neighborhoods, and rural areas.

All-Terrain Adaptability: This versatility ensures that the porch bot can handle unexpected changes in terrain, such as navigating over curbs, gravel, or uneven surfaces, making it a highly adaptable solution for last-mile delivery challenges.

### Automated Loading and Unloading:

Mother Bot Integration: The mother bot enhances operational efficiency by automating the lifting, loading, and unloading processes of porch bots. This reduces the need for manual intervention, streamlines logistics, and accelerates the delivery process, making the system suitable for high-volume, rapid delivery operations.

Improved Safety and Precision: The automation of loading and unloading reduces the risk of damage to products during handling, ensuring that delicate or high-value items are transported safely and efficiently.

### Real-Time Tracking and Monitoring:

Transparent Delivery Operations: The system's integrated navigation and communication technologies allow for real-time tracking of deliveries. Customers and operators can monitor the progress of deliveries in real time, providing transparency and improving customer satisfaction through accurate and up-to-date delivery information.

Proactive Issue Resolution: By enabling real-time monitoring, the system allows operators to quickly identify and address issues such as delays, detours, or temperature fluctuations, ensuring that the delivery process remains smooth and reliable.

### Scalability and Flexibility:

Adaptable to Various Industries: The invention's versatile design makes it applicable across a wide range of industries, from food delivery and pharmaceuticals to electronics and retail. The system can be scaled to meet the needs of small businesses, large corporations, or even public sector operations.

Future-Proof Design: The system is built to accommodate future technological advancements, such as AI improvements, more efficient energy storage solutions, or enhanced sensor technologies, making it a long-term solution that can evolve with the needs of the market.

The invention provides a multifaceted solution to the challenges of autonomous product delivery, combining advanced environmental control, energy efficiency, and intelligent navigation. Its versatile mobility, automation capabilities, and real-time monitoring further distinguish it from existing systems, making it a powerful tool for modern logistics and delivery operations. This comprehensive approach results in more reliable, scalable, and sustainable delivery processes, addressing key limitations in the prior art and setting a new standard for the future of autonomous delivery systems.

The invention has been described by way of examples only. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the claims.

Although the invention has been explained in relation to various embodiments, it is to be understood that many other possible modifications and variations can be made without departing from the spirit and scope of the invention.

1. A porch bot for transporting a plurality of products, the first of said plurality of products being a first product, comprising
a storage shell having a shelved interior for storing said plurality of products on a plurality of shelves, the first of said plurality of shelves being a first shelf,
a pair of brace rails on two external sides of said storage shell, and
a handle frame displaceable along one of said pair of brace rails to a fixed position in register with said plurality of shelves to support said plurality of products configured to slide out of said shelved interior.

2. The porch bot of claim 1 wherein transporting products comprises delivery from a vendor to an address.

3. The porch bot of claim 1 wherein transporting products comprises maintaining a product temperature of less than four degrees Celsius.

4. The porch bot of claim 1 wherein transporting products comprises maintaining a product temperature of less than negative seventeen degrees Celsius.

5. The porch bot of claim 1 wherein transporting products comprises maintaining a product temperature of above fifty degrees Celsius.

6. The porch bot of claim 1 wherein said handle frame comprises a pair of arms which clasp opposite sides of said storage shell including a plurality of sides comprising a door into said shelved interior.

7. The porch bot of claim 1 further comprising at least a first and a second separate interior compartment.

8. The porch bot of claim 1 further comprising a cooling apparatus for maintaining cooler interior temperatures relative to an environment comprising dry ice.

9. The porch bot of claim 1 further comprising a heating apparatus for maintaining warmer interior temperatures relative to an environment comprising radiant electric heat.

10. The porch bot of claim 1 wherein said storage shell further comprises a plurality of all-weather seals said plurality of all-weather seals including at least a first all-weather seal to make said storage shell wind-tight and a second all-weather seal to make said storage shell water-tight.

11. The porch bot of claim 1 further comprising omni wheels wherein said omni wheels are powered and remotely controlled.

12. The porch bot of claim 1 further comprising a battery/power storage further comprising a sharable power transfer.

13. The porch bot of claim 1 further comprising a plurality of image/video display panels further comprising a flat video display and an audio system.

14. The porch bot of claim 1 further comprising a navigation system, a GPS, and position streaming system enhanced in over/under layers with at least one of
a location tracking label comprising any combination of planet codes, cubic codes, bar codes, and tracking identifiers,
a plurality of optical/video systems integration comprising any combination of ultra violet, infrared, and/or satellite imagery, and/or
a geolocation data.

15. A mother bot for lifting and transporting one or more porch bots comprising
a bed having a side to support said porch bots, and
an adjustable height lift connected to an opposite side of said bed from said side to support said porch bots,
wherein said adjustable height lift is configured to raise, lower, and transport said bed from a surface.

16. The mother bot according to claim 15 wherein said adjustable height lift comprises at least one scissor lift having a plurality of legs, two of said plurality of legs being first leg and a second leg one of each connected between opposite sides of said bed to support said porch bots wherein said plurality of legs have rolling wheels at a free end distal from said bed to roll on said surface to transport said mother bot.

17. The mother bot according to claim 15 wherein said adjustable height lift further comprises omni wheels wherein said omni wheels are powered and remotely controlled.

18. The mother bot according to claim 15 wherein said adjustable height lift is powered and remotely controlled.

19. The mother bot according to claim 15 further comprising a battery/power storage further comprising a sharable power transfer.

20. The mother bot according to claim 15 further comprising a means of assisting said porch bots in maintaining a product temperature of less than four degrees Celsius.

21. The mother bot according to claim 15 further comprising a means of assisting said porch bots in maintaining a product temperature of less than negative seventeen degrees Celsius.

22. The mother bot according to claim 15 further comprising a means of assisting said porch bots in maintaining a product temperature of above fifty degrees Celsius.
